(19) United States
(12) Patent Application Publication
(10) Pub. No.: US 2008/0311538 A1
(43) Pub. Date: Dec. 18, 2008

(54) DENTAL DRILL STOP

(76) Inventor: Joseph Zimmer, Seattle, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 11/763,034

(22) Filed: Jun. 14, 2007

(51) Int. Cl. A61C 3/00

(52) U.S. Cl. 433/72

(57) ABSTRACT

A dental drill stop that is couplable with a dental drill to provide guidance for a dental surgeon regarding proper drill depth for drilling into a portion of a patient such as the patient's jawbone or gum tissue and jawbone.

### FIELD OF THE INVENTION

This invention is related to dental drills.

### BACKGROUND OF THE INVENTION

Dental implants are used to replace natural teeth by securing one or more of the implants to a jawbone of a patient. Conventional methods involve use of a conventional dental drill 10 such as shown in FIG. 1 to drill a hole into the jawbone of the patient to allow for placement of an anchoring portion of the implant into the jawbone. The dental drill 10 includes a dental drill bit 12 received by a powered portion 14, which imparts rotational energy to the dental drill bit. The dental drill bit 12 includes a cutting portion 16 and a shank portion 18 having a engagement end portion 20 with notches 22 to securely engage with the powered portion 14. Other implementations of the conventional dental drill 10 may use other approaches to couple the dental drill bit 12 to the powered portion 14.

A concern exist as to the depth to which the hole is drilled since too great of a drill depth can damage tissue, nerves and other portions of the patient and too small of a drill depth can result in an unsecured dental implant. Unfortunately, conventional approaches to obtain proper drill depth can put an undue burden on the dental surgeon or other operator performing the drilling operation.

### BRIEF DESCRIPTION OF THE SEVERAL VIEWS OF THE DRAWING(S)

FIG. 1 is a side elevational sectional view of a conventional dental drill.

FIG. 2 is a side elevational sectional view of the conventional dental drill of FIG. 1 with a dental drill stop.

FIG. 3 is a side elevational sectional view of the conventional dental drill of FIG. 1 with the dental drill stop of FIG. 2 shown in cross-section.

FIG. 4 is a top perspective view of the dental drill stop of FIG. 2.

FIG. 5 is a bottom perspective view of the dental drill stop of FIG. 2.

FIG. 6 is a cross-sectional view of the dental drill stop take substantially along the line 6-6 of FIG. 4.

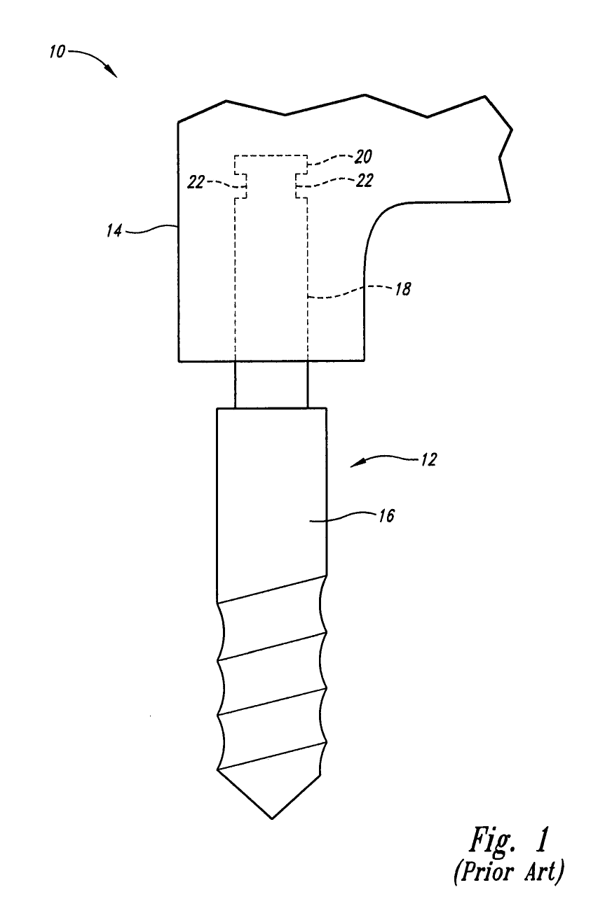

### DETAILED DESCRIPTION OF THE INVENTION

A dental drill stop is described herein that is couplable with a conventional dental drill to provide guidance for a dental surgeon or the user regarding proper drill depth for drilling into a portion of a patient such as the patient's jawbone or gum tissue and jawbone.

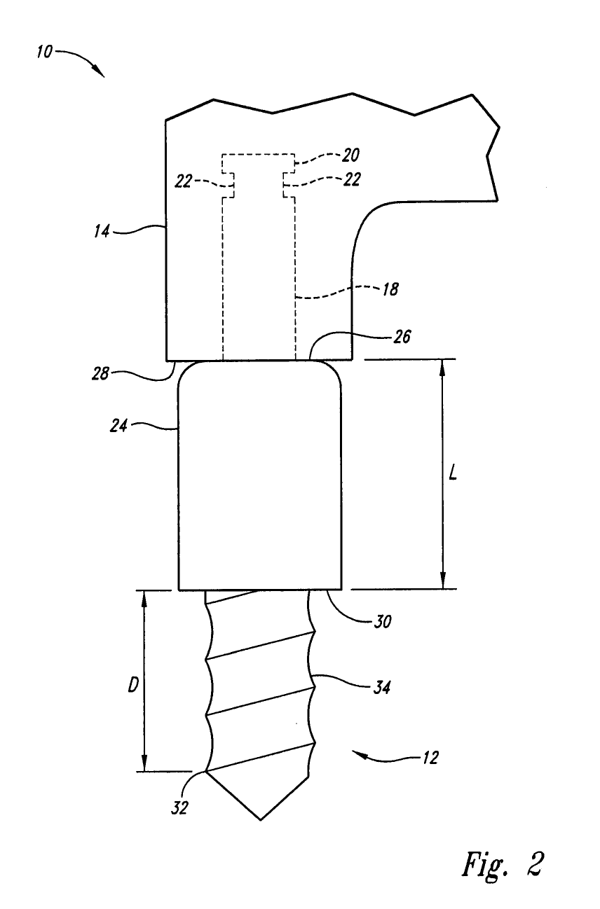

A drill bit stop 24 is shown in FIG. 2 coupled with the conventional dental drill 10 in which a first end surface 26 of the drill bit stop abuts with an end surface 28 of the powered portion 14 of the conventional dental drill. Extending away from the powered portion 14, the drill bit stop 24 has a free second end surface 30 that is spaced by a distance, D, from an end point 32 on an exposed portion 34 of the dental drill bit 12 not covered by the drill bit stop. The distance, D, is the desired depth of a substantially constant diameter portion of a hole of be drilled. When the dental drill stop 24 is used with the dental drill 10 to drill a hole in a jawbone of a dental patient, the exposed portion 34 of the dental drill bit 12 will first proceed through a surface of the gum tissue of a patient, then through the gum tissue of the patient and into the jawbone of the patient.

As the dental drill bit 12 progresses farther into the jawbone, the second end surface 30 of the drill bit stop 24 will eventually make contact with the surface of the gum tissue of the patient thereby preventing the exposed portion 34 of the dental drill bit 12 from proceeding further into the jawbone of the patient. To prepare for such a drilling procedure, a certain size of the drill bit stop 24 will be chosen with a certain length, L, to allow the exposed portion 34 of the dental drill bit to produce the substantially constant diameter hole of a depth substantially equal to the distance, D, to substantially equal a measured depth of gum tissue in the drilling location and the desired drill depth into the jawbone.

In some alternative applications, a jawbone can be drilled into directly without the dental drill bit 12 first going through gum tissue. For these alternative applications, a drill bit stop 24 will be chosen with the length, L, selected so that the exposed portion 34 of the dental drill bit 12 will produce the substantially constant diameter hole of a depth substantially equal to the distance, D, entirely in the jawbone. In other applications, a drill bit stop 24 will be chosen with the length, L, with an associated distance, D, of the exposed portion 34 of the dental drill bit 12 for a hole depth of another configuration.

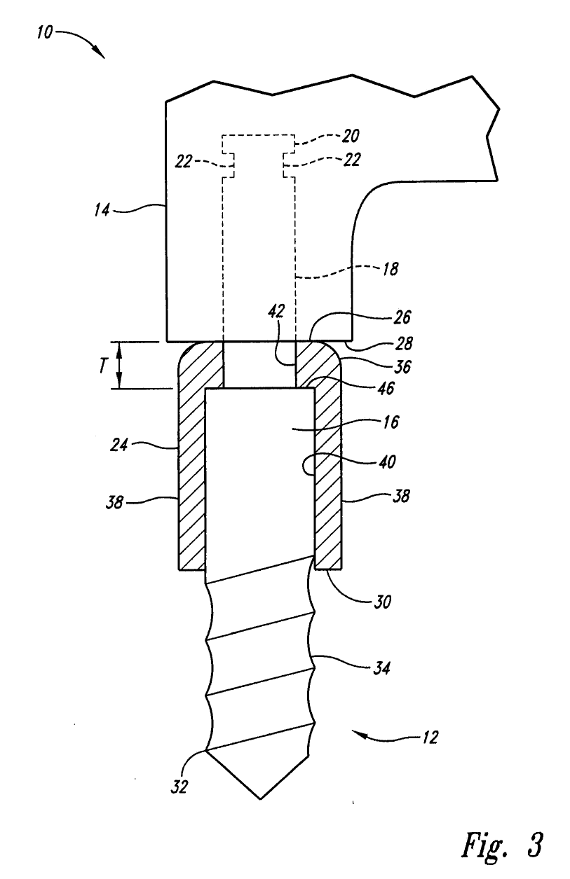

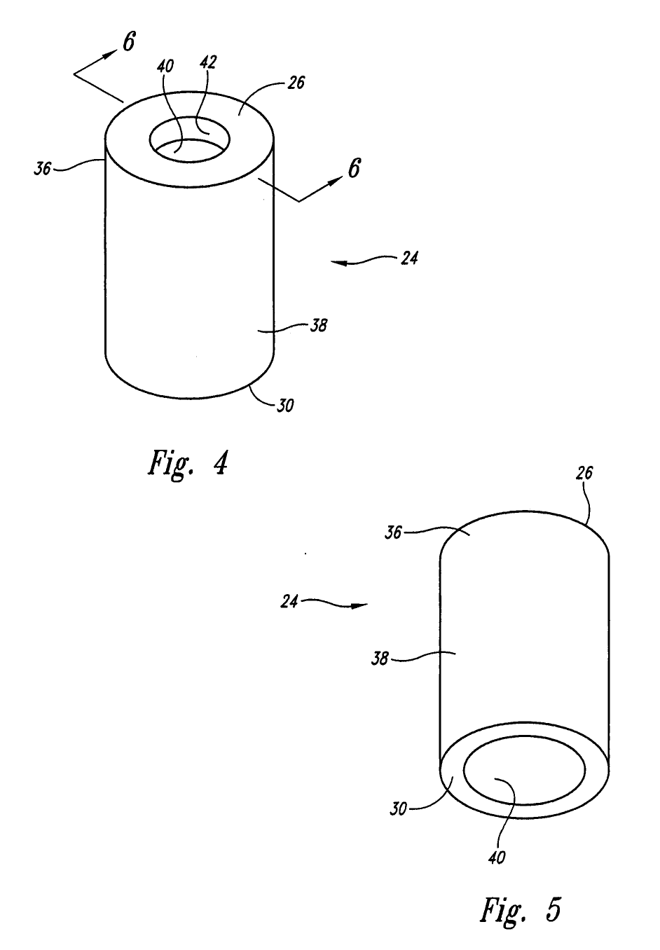

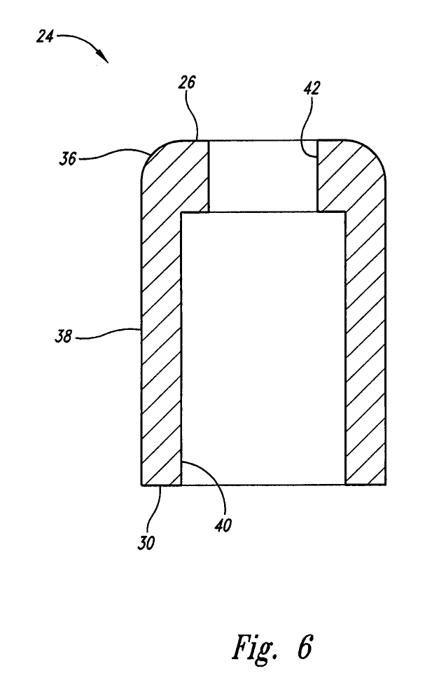

As further shown in FIGS. 3-6, the drill bit stop 24 has a generally cup shape with a base portion 36 and a side wall portion 38 (depicted as a cylindrical wall) extending therefrom with an interior space 40 sized to receive an upper portion of the cutting portion 16 of the dental drill bit 12. The base portion 36 has a hole 42 sized to receive the shank portion 18 of the dental drill bit 12 therethrough. The base portion has a thickness, T, sized to substantially equal the spacing between the end surface 28 of the powered portion 14 and an end surface 46 of the cutting portion 16 of the dental drill bit 12.

From the foregoing it will be appreciated that, although specific embodiments of the invention have been described herein for purposes of illustration, various modifications may be made without deviating from the spirit and scope of the invention. For instance, in alternative implementations, the drill bit stop 24 may have a differently shaped side wall portion 38, such as polygonal instead of cylindrical. In other implementations, the wall portion 38 could be segmented rather than continuous so long as a sufficient surface area for the first end surface 26 and the free second end surface 30 of the drill bit stop 24 exists for support purposes. Accordingly, the invention is not limited except as by the appended claims.

The invention claimed is:

1. For a dental drill having a drill bit, the drill bit having a cutting portion with an end surface and a shank portion extending from the cutting portion, the dental drill having a powered portion with an end surface, the drill bit coupled with the powered portion to provide a first space between the end surface of the cutting portion and the end surface of the powered portion, a dental drill stop comprising:
a base portion having a thickness not greater than the first space, the base portion having a hole sized to receive a portion of the shank portion therethrough, the base portion having an end surface; and
a wall portion shaped and sized to define an interior space to receive a portion of the cutting portion, the wall portion having an end surface, the dental drill stop having a predefined length, L, extending from the end surface of the base portion to the end surface of the wall portion to cover that portion of the shank portion extending between the powered portion and the cutting portion and to cover a first portion of the cutting portion and to leaving exposed a second portion of the cutting portion.

2. The dental drill stop of claim 1 wherein the thickness of the base portion is substantially equal to the first space.

3. The dental drill stop of claim 1 wherein the wall portion defines a cylinder.

4. A dental drill comprising:
a drill bit, the drill bit having a cutting portion with a free end surface and a shank portion extending from the cutting portion opposite the free end surface;
a powered portion with an end surface, the drill bit couplable with the powered portion to provide a first space between the end surface of the cutting portion and the end surface of the powered portion; and
a dental drill stop including:
a base portion having a thickness not greater than the first space, the base portion having a hole sized to receive a portion of the shank portion therethrough, the base portion having an end surface facing toward the end surface of the powered portion; and
a wall portion shaped and sized to define an interior space to receive a portion of the cutting portion, the wall portion having an end surface spaced away from the end surface of the base portion, the dental drill stop having a predefined length, L, extending from the end surface of the base portion to the end surface of the wall portion to cover that portion of the shank portion extending between the powered portion and the cutting portion and to cover a first portion of the cutting portion while leaving exposed a second portion of the cutting portion toward the free end surface.

5. The dental drill stop of claim 4 wherein the thickness of the base portion is substantially equal to the first space.

6. The dental drill stop of claim 4 wherein the wall portion defines a cylinder.

7. For a dental drill having a drill bit, the drill bit having a cutting portion with an end surface and a shank portion extending from the cutting portion, the dental drill having a powered portion with an end surface, the drill bit coupled with the powered portion to provide a first space between the end surface of the cutting portion and the end surface of the powered portion, a dental drill stop comprising:
a cup shaped member having a base portion and a side wall portion, the base portion having a thickness not greater than the first space, the base portion having a hole sized to receive a portion of the shank portion therethrough, the side wall portion shaped and sized to define an interior space to receive less than all of the cutting portion therein.

8. The dental drill stop of claim 7 wherein the thickness of the base portion is substantially equal to the first space.

9. The dental drill stop of claim 7 wherein the side wall portion defines a cylinder.

10. A dental drill comprising:
a drill bit, the drill bit having a cutting portion with an end surface and a shank portion extending from the cutting portion;
a powered portion with an end surface, the drill bit couplable with the powered portion to provide a first space between the end surface of the cutting portion and the end surface of the powered portion; and
a cup shaped member having a base portion and a side wall portion, the base portion having a thickness not greater than the first space, the base portion having a hole sized to receive a portion of the shank portion therethrough, the side wall portion shaped and sized to define an interior space to receive less than all of the cutting portion therein.

11. The dental drill stop of claim 10 wherein the thickness of the base portion is substantially equal to the first space.

12. The dental drill stop of claim 10 wherein the side wall portion defines a cylinder.
